(19) United States
(12) Patent Application Publication
(10) Pub. No.: US 2021/0248217 A1
(43) Pub. Date: Aug. 12, 2021

(54) USER AUTHENTICATION USING PRIMARY BIOMETRIC AND CONCEALED MARKERS

(71) Applicants: Sujay Abhay Phadke, Pune (IN); Binata Abhay Phadke, Pune (IN)

(72) Inventors: Sujay Abhay Phadke, Pune (IN); Binata Abhay Phadke, Pune (IN)

(21) Appl. No.: 16/785,570

(22) Filed: Feb. 8, 2020

(51) Int. Cl. G06F 21/32; G06K 9/00; G06F 21/40

(52) U.S. Cl. CPC G06F 21/32; G06K 9/00087; G06F 21/40; G06K 2009/00328; G06K 9/00288; G06K 9/00268; G06K 9/00067

(57) ABSTRACT

For user authentication, a user is registered using a biometric capturing device to capture a biometric marker from the user. The user presents the biometric marker to the capturing device with secondary characteristics selected by the user. The secondary characteristics pertain to a manner in which the user presents the biometric marker to the capturing device. Identification values for the captured biometric marker and identification values for the secondary characteristics are stored for use in identifying the user. The user is authenticated on an end terminal device at a time after registering the user. New identification values for the recaptured biometric marker and new identification values for the secondary characteristics are extracted from the newly captured biometric marker, new identification values for the recaptured biometric marker and new identification values for the secondary characteristics and used to confirm identification of the user.

### BACKGROUND

Currently deployed biometric authentication systems perform user authentication by analyzing unique features present in biometric data provided by the user. For example, fingerprint sensors extract location of minutiae present in fingerprint pattern, facial recognition algorithms extract coordinates of facial features such as eyes, ears, nose, mouth etc. These features are unique to an individual and are used to authenticate the user either locally on the device or over the cloud. However, in order to perform accurate authentication with zero rate of false identification, most systems request the user to provide an additional input such as second fingerprint, another biometric input or non-biometric inputs such as passcodes, pin codes etc. Based on these two or more factors provided by the user, these systems are able to distinguish between people with similar features and find a right match.

### BRIEF DESCRIPTION OF THE DRAWINGS

FIG. 1 is a simplified block diagram of an architecture of a cloud based biometric transaction system.

FIG. 2 illustrates use of a fingerprint sensor.

FIG. 3 illustrates use of a fingerprint sensor to extract concealed marker data in accordance with an implementation.

FIG. 4 and FIG. 5 shows a user providing concealed messages while enrolling using facial recognition in accordance with an implementation.

FIG. 6 illustrates use of a microphone 61 to register a voice as biometric data input in accordance with an implementation.

FIG. 7 illustrates a user registering a passcode as secondary non-biometric identification parameter in accordance with an implementation.

FIG. 8 illustrates a user entering hybrid biometric data in accordance with an implementation.

FIG. 9 and FIG. 10 show flowcharts illustrating logic used to authenticate a user.

FIG. 11 and FIG. 12 illustrate different levels of functionality granted to a user when the user concealed markers.

### DETAILED DESCRIPTION

Current multifactor authentication have a few lacunas. First, entering multiple independent factors for authentication lengthens the authentication process. Second, in extreme cases such as if two people have similar biometric features (for example identical twins with similar facial features) and use the same secondary authentication factor (use birthdate as pin code, for identical twins birthdates are same), the system may end up authenticating the wrong individual.

Third, consider a scenario where a person under threat is forced to perform biometric authentication to open up access to sensitive information. Currently biometric systems simply accept user provided input to authenticate the user or fail user authentication. If the user intentionally provides incorrect biometric input, they will be denied access and may be harmed. There is no way for the user to provide correct biometric input while conveying a hidden message that they are authenticating under threat. If this facility were to be available then the system can respond by displaying “false” sensitive information post authentication while alerting appropriate authorities in the backend to rescue the user. The description below addresses all the above issues by providing a way for the user to enter multiple layers of concealed information using a single type of biometric/non-biometric input.

The information below describes methods of accurately identifying individual using multi-layered identification parameter input provided by the user to the system. A user provides input parameter via an end terminal device for initiating authentication on the system to performing transaction. The user's input may be fingerprint(s), face scan, voice scan, other types of biometric input, secondary input such as passcode etc. In addition to the primary content of the input (primary marker), i.e., fingerprint pattern, face pattern, voice pattern, other biometric pattern, passcode characters etc., the input data contains multiple layers of intentionally introduced concealed identification parameters (concealed markers). These concealed markers can be angle of rotation of finger with respect to fingerprint sensor, angle of rotation of face with respect to camera, facial expressions shown by the user during face scan, varying amplitudes of words spoken during voice scan, varying finger pressures and wait times between punching keys etc. The Phoneless Universal Transaction System (PURSE) Transaction Device Interface Server (TDIS) described herein uses both primary and concealed markers to accurately identify the individual and perform desired online transaction. In some embodiments, depending on the concealed marker input by the user, the system grants the user corresponding level of authority or functionality on the system. In some embodiments the user may choose to intentionally enter concealed markers such that the system may realize the user is under distress. In this scenario, the system blocks the user from using the system for theft prevention optionally displays false transaction information on transaction device terminal and sends out alert messages to concerned authorities.

A user can input one or more layers of concealed messages (also called concealed markers) along with their primary biometric data (also called primary biometric marker) and secondary data (also called secondary marker such as passcode, pin code, second biometric input etc.).

For example, authenticating a user, can include registering a user, using a biometric capturing device to capture a biometric marker from the user. For example, the user presents the biometric marker to the capturing device with secondary characteristics selected by the user. For example, the secondary characteristics pertain to a manner in which the user presents the biometric marker to the capturing device. For example, the capturing device captures the secondary characteristics along with the biometric marker, including storing identification values for the captured biometric marker and identification values for the secondary characteristics for use in identifying the user.

For example, authenticating the user on an end terminal device at a time after registering the user includes newly capturing the biometric marker from the user at an authentication time, extracting from the newly captured biometric marker, new identification values for the recaptured biometric marker and new identification values for the secondary characteristics, and confirming identification of the user when there is a match between the stored identification values for the captured biometric marker and the new identification values for the captured biometric marker when there is both a match between the stored identification values for the captured biometric marker and the new identification values for the captured biometric marker and a match between stored identification values for the secondary characteristics and the new identification values for the secondary characteristics.

For example, the biometric marker includes a fingerprint from the user and the secondary characteristics include orientation of the fingerprint. For example, the biometric marker includes facial featured captured from the user and the secondary characteristics includes an amount of head tilt, a facial expression or closing of one or both eyes of the user.

For example, the biometric marker includes speech parameters captured from the user and the secondary characteristics include a particular phrase uttered by the user, relative amplitude of individual words uttered by the user, stresses placed on one or more words uttered by the user or closing of one or both eyes of the user.

For example, registering the user additionally includes receiving from the user a non-biometric marker, the non-biometric marker also being used to confirm identification of the user.

For example, the non-biometric marker is a passcode or a picture pin code.

For example, registering the user includes receiving from the user a non-biometric marker, the non-biometric marker also being used to confirm identification of the user where the user presents the non-biometric marker to the capturing device with secondary characteristics for the non-biometric marker selected by the user. The secondary characteristics for the non-biometric marker pertain to a manner in which the user presents the non-biometric marker to the capturing device, the non-biometric marker and the secondary characteristics for the non-biometric marker also being used to confirm identification of the user.

For example, the non-biometric marker is a pass code typed on a keyboard and the secondary characteristics for the non-biometric marker include relative pressure on particular keys when entering the passcode or distance of a body of the user from the keyboard, as detected by a proximity sensor as the user enters the passcode.

For example, different combinations of biometric marker, non-biometric marker and secondary characteristics are used to access different types of functionalities on the end terminal device.

For example, secondary characteristics are used to signal that the user is under duress.

For example, a transaction is rejected when there is a plurality of the identification values for the secondary characteristics for use in identifying the user and there is not a match between all the identification values for the secondary characteristics for use in identifying the user and the new identification values for the captured biometric marker.

For example, a transaction is accepted when there is a plurality of the identification values for the secondary characteristics for use in identifying the user and there is a match between a least one of the identification values for the secondary characteristics for use in identifying the user and the new identification values for the captured biometric marker.

For example, there is a plurality of the identification values for the secondary characteristics for use in identifying the user and one of the secondary characteristics is a particular sequence.

For example, when using the biometric capturing device to capture the biometric marker from the user, the biometric marker is registered multiple times with a different set of secondary characteristics that each function as a set of concealed markers, so that the user and the end terminal device can use each set of concealed markers to grant the user access to a control level or functionality associated with each set of the concealed markers.

For example, when using the biometric capturing device to capture the biometric marker from the user, the user is permitted to enter concealed markers for the biometric marker so that a subset of the concealed markers performed by the user can be used to authorize a transaction.

For example, when using the biometric capturing device to capture the biometric marker from the user, the user is permitted to enter concealed markers for the biometric marker so that all of the concealed markers need be performed by the user to authorize a transaction.

For example, when there is a plurality of the identification values for the secondary characteristics for use in identifying the user and one of the secondary characteristics is a particular sequence, wherein the user is allowed to select the sequence to include relevant markers and non-relevant markers, a sequence of only the relevant markers used to authenticate a transaction.

For example, when there is a plurality of the identification values for the secondary characteristics for use in identifying the user that are entered in a sequence by the user, the sequence not being used to authenticate a transaction.

For example, the secondary characteristics include a specific number of concealed markers entered by the user and the user is required to enter the specific number of concealed markers to initiate a transaction.

For example, the secondary characteristics include a specific number of concealed markers entered by the user in a specific sequence, the user being required to enter the specific number of concealed markers in the specific sequence to initiate a transaction.

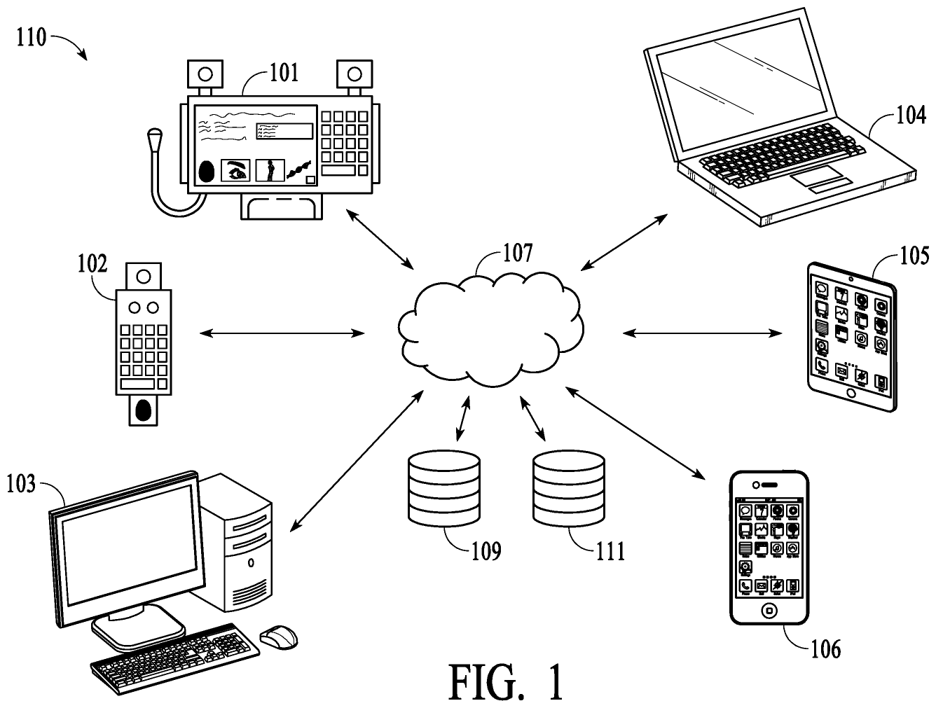

FIG. 1 describes the overall architecture of a cloud based biometric transaction system 110 called Phoneless Universal Transaction System (PURSE). PURSE consists of a Transaction Device Interface Server (TDIS) 107 made of a single or plurality of servers connected in master slave configuration. The TDIS 107 communicates with a biometric identification parameters database 109 that stores primary biometric data of enrolled users in encrypted format. Data stored on primary biometric identification parameters database may contain users' fingerprint patterns, facial feature data, voice patterns, retinal patterns, subdermal blood vessel patterns. DNA information, etc. (data that the user has). This database also stores concealed markers that the user has intentionally input while registering primary biometric data on the PURSE system (data that the user knows). Concealed marker examples can be rotation angle of finger or palm with respect to vertical axis of fingerprint sensor during enrolment, facial expressions given when registering face scan, head tilt during face scan registration, words said and their amplitudes during voice scan registration, distance of the user from end terminal device while registering biometric input etc. TDIS is also connected with a secondary identification parameters database 111 that stores non-biometric secondary identification data such as a user input passcode, picture pin code, screen patterns, sound note patterns etc. (data that the user knows) along with concealed markers intentionally entered by the user while registering secondary identification data such as pressure applied on each key while entering passcode, waiting period between pressing each key in passcode, distance the user stands away from end terminal while entering secondary identification data etc. (data that the user knows).

The TDIS connects with end terminal devices over internet. These end terminal devices run different software applications that allow the user to perform various types of transactions over the internet. Users enter their biometric and secondary identification data using sensors present on these end terminal devices to perform authentications required for the transactions. Modular end terminal devices that form part of the PURSE such as a device 101 that has face scan camera, retinal scan sensor, palm fingerprint sensor, microphone for voice scan, keypad and touchscreen; a device 102 that has only face recognition camera, fingerprint sensor, keypad and display LEDs and other multiform modular devices connect to TDIS via internet. Other terminal devices that do not form part of PURSE such as a laptop terminal device 104, a tablet terminal device 105, a smartphone terminal device 106, a work station or a server terminal device 103 etc. can also connect to TDIS via the internet provided they run software applications that are compatible with PURSE.

When a user registers their primary biometric identification parameters data and secondary identification parameters data on PURSE, they can choose to provide multiple layers of hidden messages with each type of data input. These hidden messages hence forth referred to as concealed markers can be used to provide functionality of multifactor user authentication using a single factor user input. Also depending the nature of concealed markers input by the user, the system can enable different functionality types on end terminal software, grant the user different levels of access control on end terminal software or even generate alerts if the user enters concealed markers corresponding to being under threat or distress.

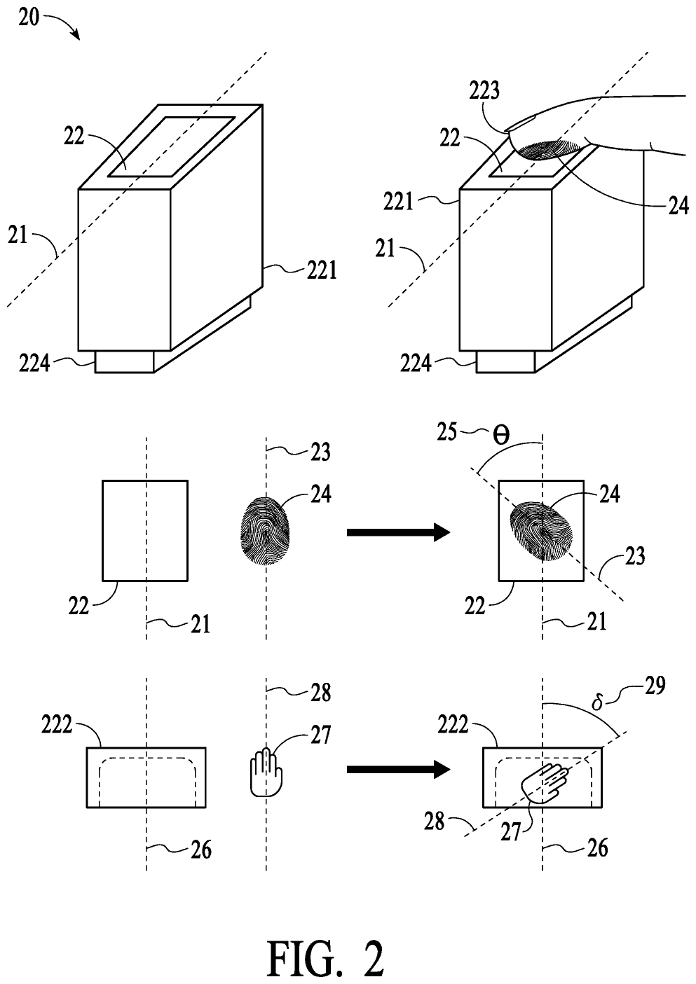

Concealed markers can be input for various types of biometric identification modes. FIG. 2 shows an example of the user entering a primary biometric identification parameter with fingerprint pattern as a primary biometric marker, finger angle of rotation as a first concealed marker and finger force exerted on fingerprint sensor as a second concealed marker. A fingerprinting device 221 has a fingerprint sensing surface 22. The longitudinal axis 21 of sensing surface 22 is a reference axis with respect to which angle of rotation of fingerprint pattern is calculated as the first concealed marker. A load cell 224 attached to the bottom of the fingerprinting device 221 senses the force exerted by the user on fingerprinting device during fingerprint registration/authentication. The fingerprinting device and load cell form a part of the body of PURSE end terminal devices such as terminal device 101 and terminal device 102 shown in FIG. 1. Optionally end terminal devices of type terminal device 103, terminal device 104, terminal device 105 and terminal device 106 may also have similar fingerprinting devices and load cell combinations mounted on them.

For example, for registering as a new user on PURSE, a user enters their fingerprint using fingerprinting device 221 by placing their finger 223 on the sensing surface 22 at an angle to longitudinal axis 21. The sensing surface 22 captures a fingerprint pattern 24 whose fingerprint longitudinal axis 23 forms an angle 25 (i.e. θ) with respect to axis 21. The end terminal device encrypts the raw data captured from fingerprint sensor and sends it to PURSE TDIS for storage on appropriate database. End terminal device also senses the force exerted by the user's finger during registration process using load cell 224. The end terminal device also encrypts this data and sends it to TDIS along with raw data captured from fingerprint sensor for storage on appropriate database. As later shown, the TDIS will compute angle 25 using algorithms. The TDIS will store fingerprint pattern on biometric database as the user's primary biometric marker, angle 25 as the user's first concealed marker and exerted force data as the user's second concealed marker.

For example, a user may choose to scan their entire palm 27 on palm sensor 222. The palm sensor may capture fingerprint patterns of multiple fingers or subdermal blood vessel pattern of palm. The user may place their palm such that the palm's longitudinal axis 28 forms an angle 29 with respect to palm sensor's longitudinal axis 26. In addition, the palm sensor may also register the force exerted by the user's palm on the sensor during registration. The end user terminal on which this palm sensor is mounted may send raw sensor data along with force data in encrypted form to TDIS. The TDIS may then extract the user's palm fingerprint patterns or palm blood vessel pattern and compute angle 29 (i.e. 6). The TDIS may store the user's fingerprint patterns or the user's subdermal blood vessel pattern as a primary biometric marker on biometric database. The TDIS may store angle 29 as a first concealed marker and force exerted on sensor as a second concealed marker on biometric database.

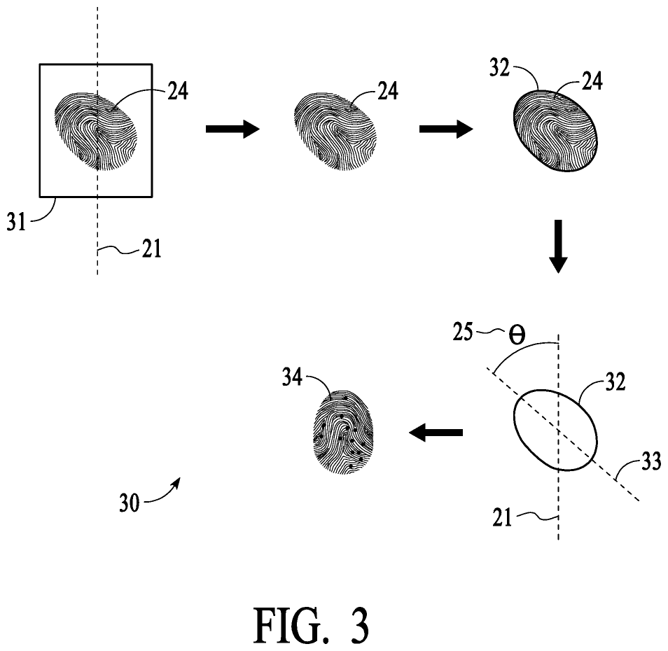

To highlight how the TDIS extracts concealed marker data let's look at the first example discussed above where a user enters single finger data to register on the PURSE. The TDIS reconstructs a fingerprint image 31 from encrypted raw fingerprint data sent by the end terminal device, as illustrated in FIG. 3. The vertical center axis of the reconstructed fingerprint image and the longitudinal axis of the fingerprint sensor sensing screen 21 co-inside and are one and the same. In this embodiment, the region where the finger touches the sensing screen corresponds to fingerprint pattern represented by dark pixel intensities 24 in the reconstructed image 31. The TDIS extracts fingerprint pattern 24 from reconstructed image 31 by computing pixel intensities of nearest neighboring pixels and using pixel gradient values to find fingerprint pattern boundaries. Alternatively, well-established algorithms such as Canny edge detection algorithm etc. can also be employed to extract fingerprint pattern 24 from reconstructed image 31. Once the fingerprint pattern 24 is extracted, the TDIS fits a bounding curve such as an ellipse 32 around the fingerprint pattern using standard curve fitting algorithms such as least squares fit etc. The TDIS then determines the orientation of major axis 33 of ellipse 32. The TDIS then computes the angle 25 (i.e., 0) between fingerprint sensor longitudinal axis 21 and ellipse major axis 33. The TDIS then realigns the fingerprint pattern in vertical orientation such as to negate the angle of orientation 25 of the major axis of the bounding ellipse. The TDIS then performs fingerprint pattern analysis and finds polar coordinates of minutiae on fingerprint pattern. These polar coordinates of minutiae data constitute a primary biometric marker of the user and are stored in encrypted format on biometric database 109. This stored primary biometric marker data is associated with the user's unique identification number (UIN) assigned by PURSE to the registering user. The TDIS also stores finger angle of orientation 25 data in encrypted format as first concealed marker on biometric database and associates this first concealed marker with the user's UIN and primary biometric marker. The TDIS also stores the finger force data in encrypted format as second concealed marker on biometric database and associates this second concealed marker with the user's UIN and primary biometric marker. A user may choose to enter same fingerprint data with varying angles of finger orientation and forces applied in order to avail different types of functionalities on end user software applications or to avail different levels of access control on end user software applications. This will be discussed in more details later in the disclosure.

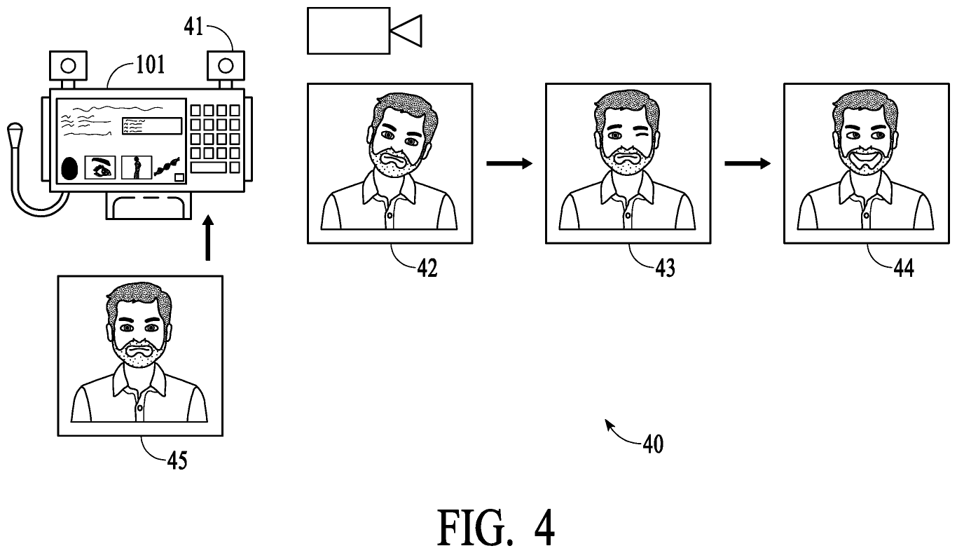

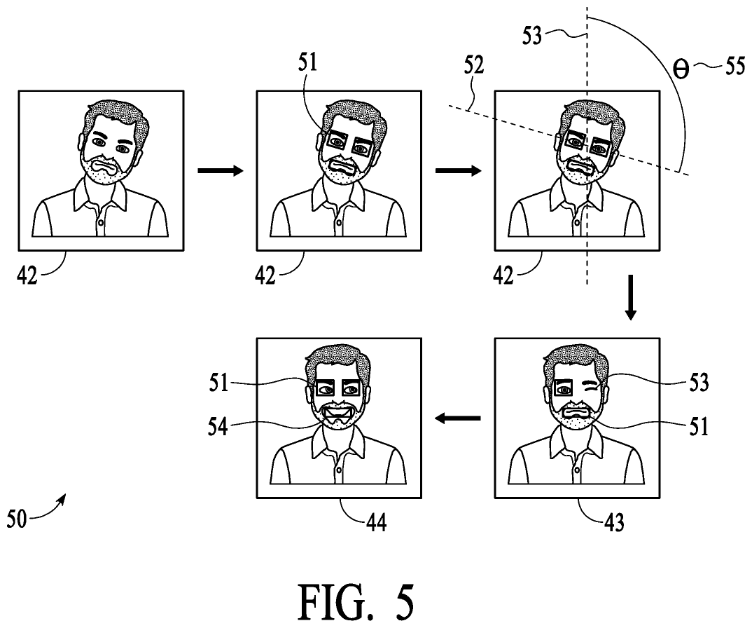

FIG. 4 and FIG. 5 shows an example of an implementation where a user 45 provides concealed messages while enrolling using facial recognition. The end terminal device 101 has camera 41 that records video of registering the user. The user records video where they first tilt their head while keeping a blank expression 42. After two seconds the user straightens their head and winks with their left eye 43. Five seconds later the user smiles with both eyes open 44. The end terminal encrypts this video file and sends the recorded data to TDIS for registering the user's facial biometric data.

The TDIS unencrypts and reconstructs the video file sent by end terminal device 101. As shown in FIG. 5, the TDIS starts analyzing frames present in the video. The TDIS first encounters frame where the user has their head tilted with a blank expression 42. The TDIS analyses this frame using a facial recognition algorithm (such as LBPH, Haar Cascades classifier etc.) and finds coordinates of various facial features such as eyes, nose, ears, mouth etc. shown by representative bounding boxes 51. Based on coordinates of eyes (and their bounding boxes), the TDIS draws a line 52 connecting the two eyes. The TDIS also constructs a reference axis 53 that is the central vertical axis of the image frame. Using co-ordinate geometry algorithms, the TDIS computes angle 55 (i.e. θ) between line 52 and axis 53. The value of angle 55, equal to θ degrees, is recorded by TDIS.

The TDIS rotates the detected facial features' coordinates so as to represent a vertically aligned face (negating face tilt angle θ) then encrypts and stores the newly computed facial feature coordinates (corresponding to vertically aligned face) as the user's a primary biometric marker on biometric database. The TDIS associates the user's primary biometric marker with UIN. The TDIS encrypts and stores angle θ as a first concealed marker on biometric database. The TDIS associates the first concealed marker with the user's primary biometric marker and UIN.

The TDIS analyses next set of frames until it computes that the user has changed the orientation of their head (based on dynamically calculating angle 55 between line 52 and axis 53) and has made it vertical (angle 55 equals 90 degrees). The TDIS also runs facial recognition algorithms and finds that in one (or more) of the frames, one of the user's facial features is missing viz the user's left eye. This is the frame where the user winked as described above.

The TDIS notes the time elapsed since capturing first frame of the video until the current frame where the user is winking. This time is recorded at T1. The TDIS encrypts and stores T1 on biometric database as a second concealed marker. The TDIS associates the second concealed marker with UIN and the user's primary concealed marker. The act of winking may be recorded as coordinates of detected facial features in frame missing coordinates of the user's left eye. This data is encrypted and stored on biometric database as a third concealed marker. The third concealed marker is associated with UIN and the user's primary biometric marker by the TDIS.

In similar way to that described in the paragraph above, the TDIS analyses a next set of frames until it encounters the user's grinning expression 44. Grin shown by bounded box 54 can be detected by face recognition algorithms that measure change in pixel intensity and hue values near the user's mouth (facial feature region 54). The user's teeth will have different pixel intensity and hue compared to lips and skin in an image frame. The TDIS computes time elapsed T2 between the previous wink expression and current grinning expression. The TDIS calculates the coordinates of the mouth facial feature, nose facial feature and the two ears.

The TDIS then computes distance between left edge of mouth facial feature and left ear, distance between right edge of mouth and right ear and gap between the nose and mouth facial features. The TDIS then encrypts and stores set of these three calculated distances as a fourth concealed marker on the biometric database. The TDIS also encrypts and stores time T2 as a fifth concealed marker on the biometric database. Both the fourth and fifth concealed markers are associated with the user's UIN and primary biometric marker.

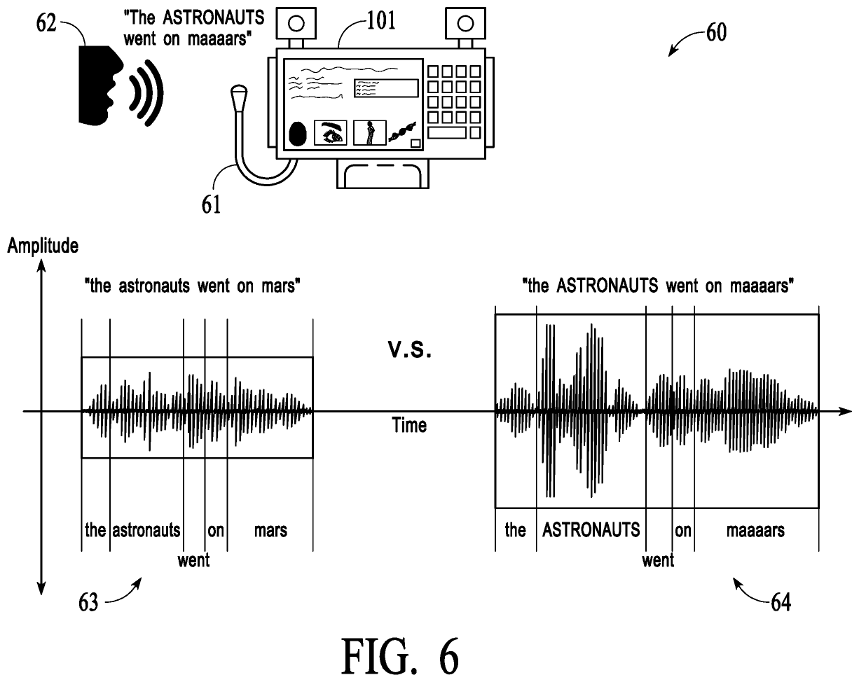

Another example is shown in FIG. 6 where the user 62 speaks into the microphone 61 of end terminal device 101 to register their voice as biometric data input. The user says “the ASTRONAUTS went on maaaars”. The end terminal device 101 sends encrypted voice data to TDIS 107 for user registration. The TDIS first runs speech analysis to isolate words and sounds spoken in the sentence. If a user has simply spoken “the astronauts went on mars” then their amplitude-time domain graph would look as shown in amplitude-time graph 63. In order to provide concealed messages, the user however says astronauts loudly (about twice the amplitude of previous word the) and stresses on “a” in mars i.e. says “maaaars” instead of simply mars. The resulting input sentence looks as depicted by amplitude-time graph 64. The TDIS extracts words/sounds “the”, “ASTRONAUTS”, “went”, “on” and “maaaars” from the sentence. The TDIS also finds average amplitude of each word spoken and computes ratio of average word amplitude with amplitude of previously spoken word (except for the first spoken word “the”). The TDIS then runs voice recognition algorithm to isolate speech parameters unique to the user. The TDIS encrypts and stores the user's speech parameters as primary biometric marker on biometric database and associates it with the user's UIN. The TDIS stores extracted words/sounds as a first concealed marker, encrypts and stores it on biometric database. The TDIS also stores computed average word amplitude ratios as a second concealed marker, encrypts and stores it on biometric database. The TDIS associates the first and second concealed markers with the user's primary biometric marker and UIN.

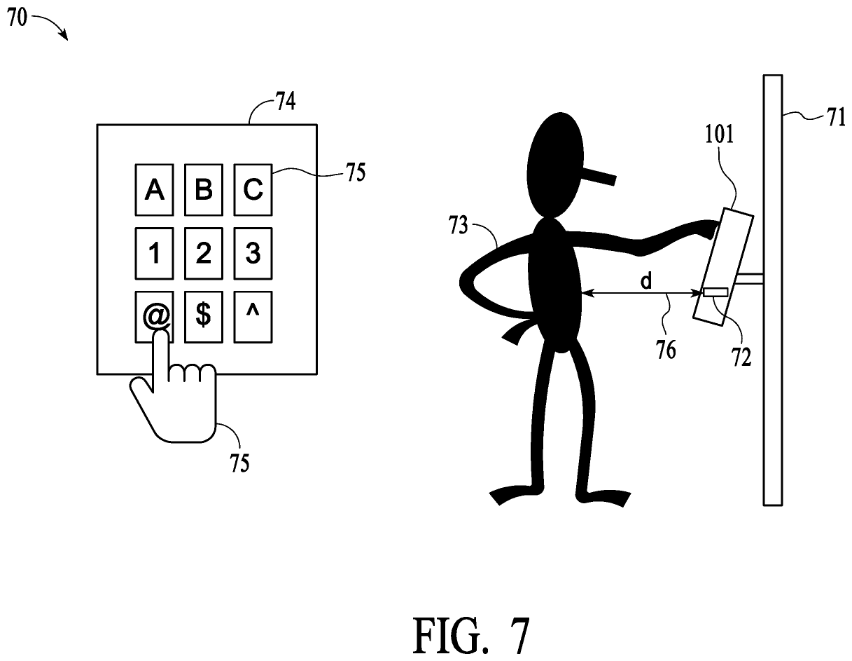

FIG. 7 shows an example of a user registering their passcode as secondary non-biometric identification parameter on PURSE. The user 73 uses an end terminal device 101 mounted on wall 71. The end terminal device 101 has an inbuilt range sensor 72 that measures the distance of the user 73 from the end terminal device 101 while entering secondary data i.e. passcode. The user 73 uses keys 75 on keypad 74 that forms part of end terminal device 101. The user 73 enters passcode A@B$. While entering the passcode, the user stands a distance 76 (i.e. d) centimeters away from end terminal device 10 as detected by range sensor 72. The user also presses @ key twice as hard as A key, B key just as hard as A key and $ key thrice as hard as A key. The user also waits 1 second after pressing A key to press @ key. The user waits 2 seconds to press B key after @ key. The user waits 1 second to press $ key after B key. The end terminal device 101 encrypts all gathered secondary data (passcode, pressures applied on each key, key stroke timings and the user's distance from end terminal device) and sends it over to TDIS for registration. The TDIS unencrypts the data, then encrypts and stores the passcode A@B$ as secondary marker on secondary identification parameters database 111. The TDIS associates secondary marker with the user's UIN generated by PURSE. The TDIS also encrypts and stores data of pressure applied on each key as a first concealed marker, timing between pressing keys as a second concealed marker and distance of the user from wall as a third concealed marker on database 111. The TDIS associates first, second and third concealed markers with the user's secondary marker and UIN.

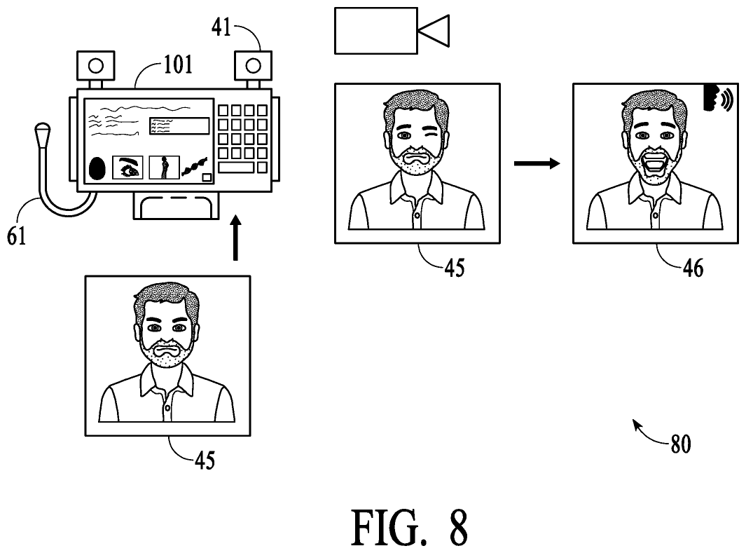

FIG. 8 shows an example where the user enters hybrid biometric data. The user 45 uses camera 41 and microphone 61 of an end terminal device 101 to record a registration video. The TDIS analyses this video to extract facial feature coordinates from blank expression 47 and the user's unique speech parameters from voice recorded 46 in the video. The TDIS stores encrypted facial feature data as primary biometric marker on biometric database 109 and associates with the user's PURSE generated UIN. The TDIS encrypts and stores the user's unique speech parameters as a first concealed marker and store it on biometric database. The TDIS associates the first concealed marker with UIN and the user's primary biometric marker.

In another implementation, the user's retinal scan pattern may constitute primary biometric marker and the distance of the user from the end terminal device 101 may constitute a first concealed marker.

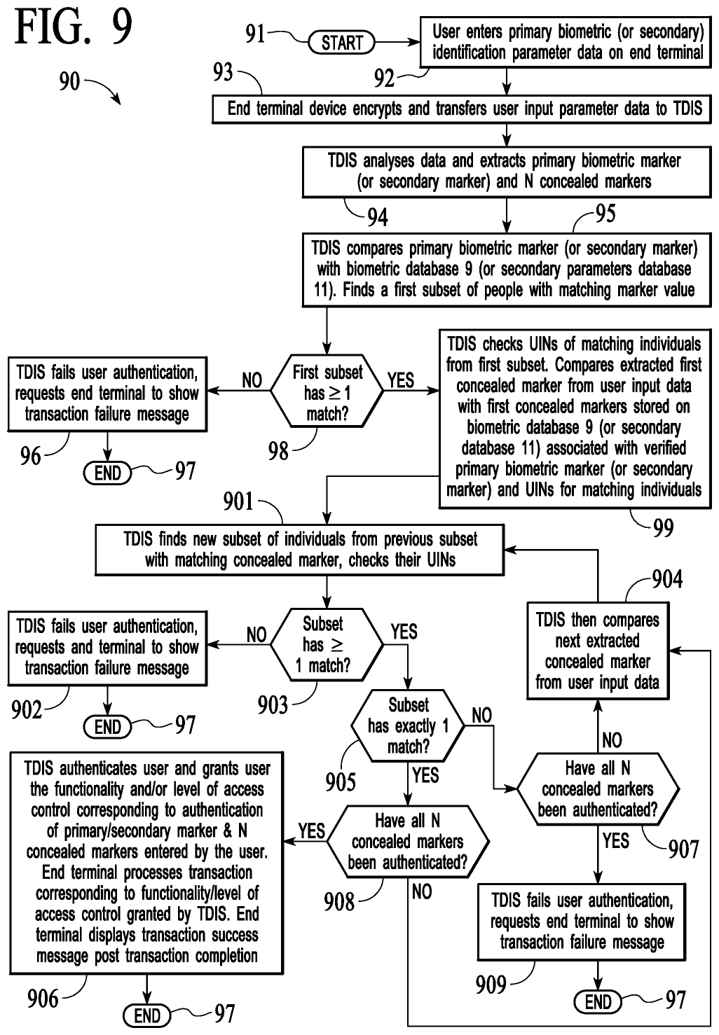

FIG. 9 shows a flowchart of the logic used by TDIS 107 to authenticate the user. To explain the authentication functionality we will take example of a user registered using video recording as described in the description of FIG. 4 above. The user has registered their facial features as primary biometric marker, head tilt angle 55 say θ=45 degrees as first concealed marker, wait time T1 to change expression to wink as second concealed marker, facial feature coordinates with missing co-ordinate for left eye (i.e. winking expression) as third concealed marker, set of three distances between mouth facial feature edges and nose/left ear/right ear while giving grinning expression as fourth concealed marker and wait time T2 to change expression to grinning as fifth concealed marker.

Authentication example one—Number of concealed markers entered by the user for performing transaction N is less than number of concealed markers registered by the user P: On some later date post registration, the user accesses an end terminal device (such as one of end terminal devices 101-106) to perform a transaction. As shown in flowchart FIG. 9, the user tilts their head and gives a blank expression as input to end terminal 92. The end user terminal encrypts and sends this data to TDIS for authentication 93. As described in the description of FIG. 4 above, and block 94 the TDIS extracts the user's facial features (rotated vertically as if head had no tilt) as primary biometric marker to verify against biometric database 109. TDIS also extracts the head tilt angle as described in in the description of FIG. 4 above and block 94 as a first concealed marker to verify against first concealed marker associated with primary biometric marker stored on biometric database 109. As shown in block 95, the TDIS then compares primary biometric marker i.e. the user's facial features (blank expression) with biometric database 109. The TDIS uses standard facial recognition algorithms such as LBPH, Haar Cascade Face Recognition, dlib etc. to identify a first subset of matching individuals as shown in block 95. As shown in block 98 if the first subset has zero matching individuals then the TDIS fails the transaction as shown in block 96 and requests end terminal to issue an authentication failure/transaction failure message.

If on the other hand, the first subset has ≥1 matching individuals then as shown in block 99 the TDIS selects UIN associated with each individual in the first subset. The TDIS then proceeds to match the first concealed marker input by the user (extracted in block 95) for individuals with selected UINs and matching primary biometric marker.

As shown in block 901 the TDIS finds a subset of people who have matching first concealed markers from within the previous subset of selected individuals. The TDIS also selects UINs of each individual within the new subset. First concealed marker in this case is the head tilt angle 55. The TDIS considers a match of first concealed marker if the head tilt angle input by the user (extracted in block 95 by the TDIS) is within a tolerance limit set by PURSE admin/superuser of head tilt angle input by the user during registration. For example if the user had registered with a first concealed marker head tilt angle of 45 degrees and if the PURSE admin/super user has put a tolerance limit of ±5 degrees then the first concealed marker input for performing transaction (block 92) will only be considered a match if the user has tilted their head within the angular range of 40 degrees≤head tilt angle input≤50 degrees. If the head is tilted too much or too less then this match will fail.

As shown in block 903, the TDIS checks if the new subset of selected individuals has ≥1 match. If the new subset has zero selected individuals then as shown in block 902, the TDIS fails transaction and requests end terminal to display authentication failure/transaction failure message.

If new subset has exactly one selected individual as shown in block 905, then the TDIS checks if all markers input by the user in block 92 (extracted in block 95) have been authenticated or not (shown in block 908).

As shown in block 906, if all concealed markers have also been authenticated (provided only one individual was selected in new subset as shown in block 905) then the TDIS authenticates the user and grants functionality or level of access control corresponding to primary and concealed markers entered by the user. The end terminal displays authentication success message and lets the user perform transaction as per functionality or level of access control granted on end terminal software application.

If however in block 905, if the new subset has >1 individual, then the TDIS, in block 907, if all user input concealed markers have been verified. In this case the user input only one concealed marker (blocks 92 and 95) so the TDIS determines that all concealed markers have been verified and that there is no unique match. The TDIS then fails transaction as shown in block 909 and requests end terminal to display authentication failure/transaction failure message.

In another embodiment even if the new subset has only one unique individual, as shown in block 905, the block 908 may be modified to also check if the number of concealed markers input by the user in block 92 equals the number of concealed markers input by the user while registering on PURSE system. If the number of concealed markers entered during current transaction (block 92) is less than the number of concealed markers input by the user during registration, then the TDIS may fail the transaction and request end terminal device to display transaction failure message.

Authentication example two—Number of concealed markers entered by the user for performing transaction N is equal to the number of concealed markers registered by the user P: In this scenario same steps are followed for authenticating primary biometric marker and first concealed marker, see the Authentication example one, described previously. If the new subset obtained after authenticating head tilt concealed marker has ≥1 matches then as shown in block 905, the TDIS checks if there was exactly one match in the new subset.

If there was exactly one match detected in block 905 then in block 908 the TDIS checks if all N concealed markers have been authenticated. If all N concealed markers have been authenticated in block 908 and there is exactly one match in block 905 then the TDIS authenticates the user and grants functionality or level of access control corresponding to primary and N concealed markers entered by the user. The end terminal displays authentication success message and lets the user perform transaction as per functionality or level of access control granted on end terminal software application.

If the TDIS detects in block 908 that there are still more concealed markers that need to be authenticated (i.e. all N concealed markers have not yet been authenticated) then the TDIS loops back to block 904 and repeats process of matching next concealed marker input by the user, as described in the paragraph discussing block 901, with different tolerance definitions set up for each concealed marker. Also instead of selecting new subset of people from first subset, in this case if the K^{th} concealed marker is being matched then the new subset of people are selected from the K^{th} subset obtained by matching K−1^{th} concealed marker, where K≤N.

Continuing Authentication example one, if the TDIS finds out in block 905 that there are two or more matching individuals, then the TDIS first checks in block 907 if all concealed markers have been authenticated. If all concealed markers have been authenticated then the TDIS then fails transaction as shown in block 909 and requests end terminal to display authentication failure/transaction failure message. If on the other hand the TDIS finds in block 907 that there are more markers left to be authenticated then it loops back to block 904 for authenticating the next marker. The TDIS repeats process of matching next concealed marker input by the user to what is done in block 901 and following, with different tolerance definitions set up for each concealed marker. Also instead of selecting new subset of people from first subset, in this case if the K^{th} concealed marker is being matched then the new subset of people are selected from the K^{th} subset obtained by matching K−1^{th} concealed marker. Note: K≤N).

After matching all N concealed markers there are three possible outcomes. First outcome is that the new subset (N+1^{th} subset) has zero matches in block 903. In this scenario the TDIS fails transaction as shown in block 902. A second possible outcome is that the new subset has more than one match in block 905. Even in this case, the TDIS fails transaction as shown in block 909. The third possible scenario is that the TDIS finds exactly one match in the new subset in block 905. In this case as shown in block 906 the TDIS authenticates the user and grants functionality or level of access control corresponding to primary and N concealed markers entered by the user. The end terminal displays authentication success message and lets the user perform transaction as per functionality or level of access control granted on end terminal software application.

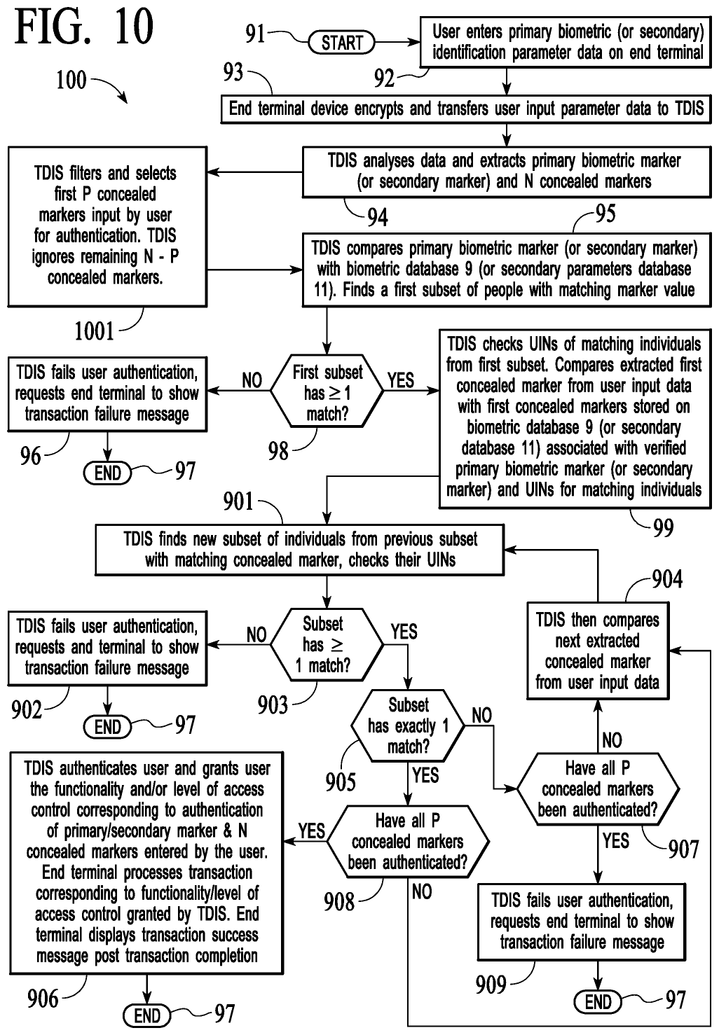

Authentication example three—Number of concealed markers entered by the user for performing transaction N is greater than the number of concealed markers registered by the user P: As shown in FIG. 10 in this case authentication happens similar to the case where N=P as in Authentication example one, with the only difference being that an additional filtering step 1001 selects only the first P concealed markers for authenticating individual while ignoring remaining N−P concealed markers.

In another embodiment of example of Authentication example three, the TDIS may verify all N concealed parameters entered by user in block 92. If P out of the N concealed parameters entered by the user produce a unique match after all N concealed parameters have been verified in block 905 then the TDIS authenticates the user via logical flow shown in blocks 908 and block 906. The end terminal displays authentication success message and lets the user perform transaction as per functionality or level of access control granted on end terminal software application.

An authentication algorithm similar to what is described in the previous paragraphs is followed while authenticating other types of primary biometric identification parameter inputs such as fingerprints, palm prints, user's voice, retinal scan, subdermal blood vessel scan etc. and for authenticating secondary identification parameter inputs such as passcodes, picture pin codes etc.

Primary or secondary data including concealed markers input by the user data end terminal device 101 can be used by PURSE TDIS to provide different types of functionality within same software application running on end terminal.

FIG. 4 shows user 46 registering on end terminal device 101 using face recognition. As discussed in the discussion of FIG. 4, the user has registered their facial features as primary biometric marker, head tilt angle 55, for example, θ=45 degrees as first concealed marker, wait time T1 to change expression to wink as second concealed marker, facial feature coordinates with missing co-ordinate for left eye (i.e. winking expression) as third concealed marker, set of three distances between mouth facial feature edges and nose/left ear/right ear while giving grinning expression as fourth concealed marker and wait time T2 to change expression to grinning as fifth concealed marker.

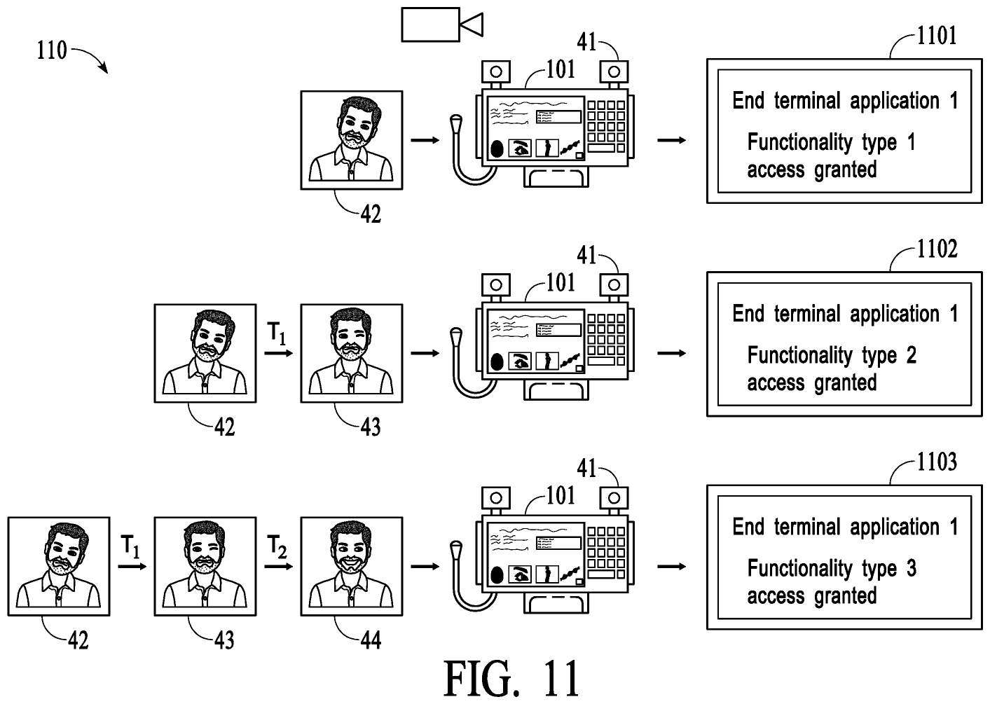

FIG. 11 shows how different levels of functionality are granted to the user on the end terminal device 101 when the user uses different number of concealed markers in same sequence.

If the user just enters just tilted head 42 in video recording then their data has facial feature as primary biometric marker and head tilt angle 55 as first concealed marker. In this case post authentication on TDIS, the TDIS grants the user functionality access type 1 on the end terminal software application.

If the user entered in the correct sequence a tilted head 42, then waited for time T1 and then winked (primary biometric marker+3 concealed markers viz. tilt angle of head, wait time T1 and winking expression i.e. missing left eye) they would be authenticated by TDIS and granted functionality type 2 on the end terminal software application.

If the user entered in the correct sequence a tilted head 42, then waited for time T1, then winked, then waited for time T2, and then grinned (primary biometric marker+5 concealed markers viz. tilt angle of head, wait time T1, winking expression i.e. missing left eye, wait time T2 and grinning expression i.e. distances of mouth facial feature edges from nose/left ear/right ear) they would be authenticated by TDIS and granted functionality type 3 on the end terminal software application.

For example, suppose that the end terminal software application corresponded to a bank ATM application. In this case, the end terminal is externally connected to a bank ATM. Of the many different types of applications that run on the end terminal, application number one can operate a connected ATM. Functionality type 1 (see end terminal GUI screen 1101) would allow the user to withdraw cash. Functionality type 2 (see end terminal GUI screen 1102) would allow the user to deposit a check. Functionality type 3 (see end terminal GUI screen 1103) would be accessed by the user if they were under physical threat to withdraw and over their money to a burglar. In this functionality (type 3) the end terminal screen would falsely show that the user's bank balance is zero dollars while alerting the police in the backend via different forms of communication (email, automated phone call, text message etc.)

In yet another implementation, functionality type 1 allows the user to perform usual banking transactions. Functionality type 2 would give the user admin rights for enabling or disabling other users from using the software application. Functionality type 3 can be superuser functionality where in addition to enabling/disabling other users/admins the user can also restock cash into the ATM machine.

In the example where the end terminal software application corresponded to bank ATM application, a user can register first primary biometric identification parameter using a recorded video. FIG. 4 shows user 46 registering on end terminal device 101 using face recognition. As discussed in the discussion of FIG. 4, the user has registered their facial features as first primary biometric marker, head tilt angle 55 say θ=45 degrees as first concealed marker, wait time T1 to change expression to wink as first second concealed marker, facial feature coordinates with missing co-ordinate for left eye (i.e. winking expression) as first third concealed marker, set of three distances between mouth facial feature edges and nose/left ear/right ear while giving grinning expression as first fourth concealed marker and wait time T2 to change expression to grinning as first fifth concealed marker.

Likewise, the user can also register a second primary biometric identification parameter using fingerprint reader 221. Registration process would be as shown in FIGS. 2 and 3 and the related description of FIGS. 2 and 3 above. This second primary biometric parameter has fingerprint pattern as second primary biometric marker, angle of rotation of finger 25 as second first concealed marker and force exerted by user's finger on loadcell 224 as second concealed marker.

Likewise, the user can also register a secondary identification parameter using keypad on end terminal device 101 as shown in FIG. 7 and the related discussion above.

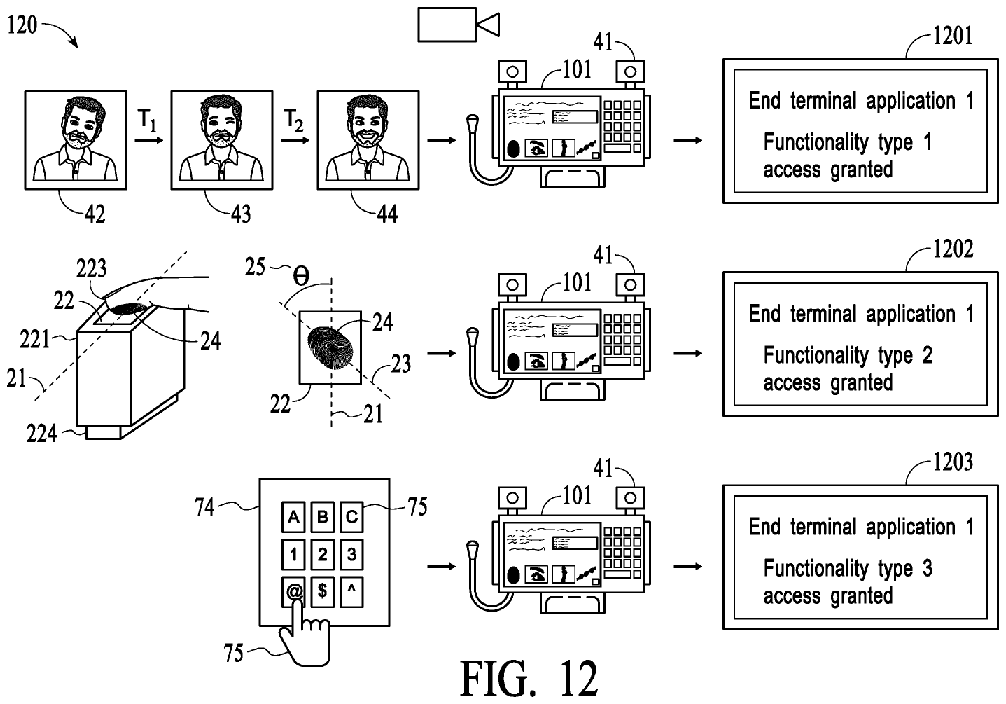

Likewise, the user can access another software application number 2 that handles retail transactions. As shown in FIG. 12, if the user enters video input the software application number 2 grants the user access to functionality type 1 (see end terminal GUI screen 1201, functionality may be making payment for grocery items shopped/user functionality). If the user inputs fingerprint data then the software application number 2 grants the user access to functionality type 2 (see end terminal GUI screen 1202, functionality may be to enter new grocery item codes into the retail ERP system/admin functionality). If the user inputs passcode using keypad 74 on end terminal device 101 then software application number 2 grants the user access to functionality type 3 (see end terminal GUI screen 1203, functionality may be to cancel a purchase transaction).

For example, other software applications running on end terminal device 101 may require the user to enter both primary biometric identification parameter and secondary identification parameter to enable each separate type of functionality. Between different functionality types, the user's primary biometric marker+associated concealed markers and secondary marker+associated concealed markers may be similar or different depending on use case.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

1. A method for authenticating a user, the method comprising:
registering a user, including:
using a biometric capturing device to capture a biometric marker from the user, including:
the user presenting the biometric marker to the capturing device with secondary characteristics selected by the user, the secondary characteristics pertaining to a manner in which the user presents the biometric marker to the capturing device, and
the capturing device capturing the secondary characteristics along with the biometric marker,
storing identification values for the captured biometric marker and identification values for the secondary characteristics for use in identifying the user;
authenticating the user on an end terminal device at a time after registering the user, including:
newly capturing the biometric marker from the user at an authentication time,
extracting from the newly captured biometric marker, new identification values for the recaptured biometric marker and new identification values for the secondary characteristics, and
confirming identification of the user when there is a match between the stored identification values for the captured biometric marker and the new identification values for the captured biometric marker when there is both a match between the stored identification values for the captured biometric marker and the new identification values for the captured biometric marker and a match between stored identification values for the secondary characteristics and the new identification values for the secondary characteristics.

2. A method as in claim 1 wherein the biometric marker includes a fingerprint from the user and the secondary characteristics include orientation of the fingerprint.

3. A method as in claim 1, wherein the biometric marker includes facial featured captured from the user and the secondary characteristics include at least one of the following:
amount of head tilt,
facial expression,
closing of one or both eyes of the user.

4. A method as in claim 1, wherein the biometric marker includes speech parameters captured from the user and the secondary characteristics include at least one of the following:
a particular phrase uttered by the user,
relative amplitude of individual words uttered by the user,
stresses placed on one or more words uttered by the user,
closing of one or both eyes of the user.

5. A method as in claim 1, wherein registering the user additionally comprises:
receiving from the user a non-biometric marker, the non-biometric marker also being used to confirm identification of the user.

6. A method as in claim 5, wherein the non-biometric marker is at least one of the following:
a passcode,
a picture pin code.

7. A method as in claim 1, wherein registering the user additionally comprises:
receiving from the user a non-biometric marker, the non-biometric marker also being used to confirm identification of the user, including:
the user presenting the non-biometric marker to the capturing device with secondary characteristics for the non-biometric marker selected by the user, the secondary characteristics for the non-biometric marker pertaining to a manner in which the user presents the non-biometric marker to the capturing device, the non-biometric marker and the secondary characteristics for the non-biometric marker also being used to confirm identification of the user.

8. A method as in claim 7 wherein the non-biometric marker is a pass code typed on a keyboard and the secondary characteristics for the non-biometric marker include at least one of the following:
relative pressure on particular keys when entering the passcode;
distance of a body of the user from the keyboard, as detected by a proximity sensor as the user enters the passcode;
timing introduced by the user between pressing each successive key.

9. A method as in claim 8 wherein different combinations of biometric marker, non-biometric marker and secondary characteristics are used to access different types of functionalities on the end terminal device.

10. A method as in claim 1 wherein secondary characteristics are also used to signal that the user is under duress.

11. A method as in claim 1, additionally comprising:
rejecting a transaction when there is a plurality of the identification values for the secondary characteristics for use in identifying the user and there is not a match between all the identification values for the secondary characteristics for use in identifying the user and the new identification values for the captured biometric marker.

12. A method as in claim 1, additionally comprising:
accepting a transaction when there is a plurality of the identification values for the secondary characteristics for use in identifying the user and there is a match between a least one of the identification values for the secondary characteristics for use in identifying the user and the new identification values for the captured biometric marker.

13. A method as in claim 1 wherein there is a plurality of the identification values for the secondary characteristics for use in identifying the user and one of the secondary characteristics is a particular sequence.

14. A method as in claim 1, wherein when using the biometric capturing device to capture the biometric marker from the user, the biometric marker is registered multiple times with a different set of secondary characteristics that each function as a set of concealed markers, so that the user and the end terminal device can use each set of concealed markers to grant the user access to a control level or functionality associated with each set of the concealed markers.

15. A method as in claim 1 wherein when using the biometric capturing device to capture the biometric marker from the user, the user is permitted to enter concealed markers for the biometric marker so that a subset of the concealed markers performed by the user can be used to authorize a transaction.

16. A method as in claim 1 wherein when using the biometric capturing device to capture the biometric marker from the user, the user is permitted to enter concealed markers for the biometric marker so that all of the concealed markers need be performed by the user to authorize a transaction.

17. A method as in claim 1 wherein there is a plurality of the identification values for the secondary characteristics for use in identifying the user and one of the secondary characteristics is a particular sequence, and wherein the user is allowed to select the sequence to include relevant markers and non-relevant markers, a sequence of only the relevant markers used to authenticate a transaction.

18. A method as in claim 1 wherein there is a plurality of the identification values for the secondary characteristics for use in identifying the user that are entered in a sequence by the user, the sequence not being used to authenticate a transaction.

19. A method as in claim 1 wherein the secondary characteristics include a specific number of concealed markers entered by the user, the user being required to enter the specific number of concealed markers to initiate a transaction.

20. A method as in claim 1 wherein the secondary characteristics include a specific number of concealed markers entered by the user in a specific sequence, the user being required to enter the specific number of concealed markers in the specific sequence to initiate a transaction.
